(19) United States
(12) Patent Application Publication
(10) Pub. No.: US 2013/0110615 A1
(43) Pub. Date: May 2, 2013

(54) SYSTEM AND METHOD FOR CONTROLLING ADVERTISEMENT BASED ON USER BENEFIT

(71) Applicant: Keonsu LEE, Seongnam-si (KR)

(72) Inventor: Keonsu LEE, Seongnam-si (KR)

(73) Assignee: NHN BUSINESS PLATFORM CORPORATION, Seongnam-si (KR)

(21) Appl. No.: 13/453,073

(22) Filed: Apr. 23, 2012

(30) Foreign Application Priority Data
Apr. 22, 2011 (KR) 10-2011-0037924
Mar. 27, 2012 (KR) 10-2012-0031013

(51) Int. Cl. G06Q 30/02

(52) U.S. Cl. CPC G06Q 30/0242
USPC 705/14.41

(57) ABSTRACT

A system to control an advertisement rank includes a storage device, an advertisement identifying unit stored on the storage device and configured to identify advertisements, the identified advertisements corresponding to a keyword, an affiliate advertisement identifying unit configured to identify an affiliate advertisement among the identified advertisements, the affiliate advertisement being associated with a user benefit, and a rank index calculating unit comprising a processor configured to calculate a rank index of the affiliate advertisement based on a value of the user benefit. A method for controlling an advertisement rank includes determining multiple advertisements corresponding to a keyword, identifying an affiliate advertisement among the identified advertisements, the affiliate advertisement being associated with a user benefit, and calculating, by the processor, a rank index of the affiliate advertisement based on a value of the user benefit.

### CROSS-REFERENCE TO RELATED APPLICATIONS

This application claims priority from and the benefit of Korean Patent Application Nos. 10-2011-0037924, filed on Apr. 22, 2011, and 10-2012-0031013, filed on Mar. 27, 2012, both of which are hereby incorporated by reference for all purposes as if fully set forth herein.

### BACKGROUND

1. Field

Exemplary embodiments of the present invention relate to a system and method for providing an advertisement, and more particularly, to a system and method for controlling an advertisement rank.

2. Discussion of the Background

Internet advertisements, in particular, keyword advertisements are ranked in various ways and then provided as search result listings to a user who inputted a keyword. For example, when five advertising products are found and provided via a search result, the advertising products may be ranked and provided based on various parameters, such as a bid amount of an advertiser providing the advertisements, the quality index of the advertisements, and the like. For example, advertisements having a higher bid amount and a higher quality index may be ranked higher and subsequently provided to users as a higher-ranked search result.

To attract interest from users and improve the advertising effects, information relating to user benefits or user compensations may also be provided when advertisements are provided as a search result. For example, information about a user benefit or user compensations, such as, for example, cash back rewards or a cash back rate to be offered after a product or service is purchased through a displayed advertisement, may be provided to a user along with corresponding advertisements. For products or services provided with user benefits or compensations, when a product or service is purchased through a displayed advertisement, a user benefit may be offered.

In this instance, a privilege or customer inducement may occur from the provision of a user benefit. When calculating a quality index of an advertisement, a post-evaluation factor of the advertisement may be reflected, such as a click factor, for example, the number of clicks or a click through rate (CTR) for an advertisement. However, the user benefit may generate noise in determining the number of clicks or CTR. Specifically, a provision of a user benefit, such as cash back rewards, may induce more user clicks for the corresponding advertisement regardless of the quality of the corresponding advertisement, website, product, service, and the like. For example, the determined number of clicks or CTR may fail to reflect advertisement exposure rank or the quality of the advertisement. Furthermore, the advertising effects based on the display rank of the advertisement may be deteriorated.

Further, advertisers may be inclined to obtain higher display ranks by providing user benefits rather than by improving the quality of advertisements. As a result, the overall quality of contents rankings provided by a publisher and the quality of advertisements to be provided to users may be degraded and a fair ranking competition among advertisers may not be achieved.

To address aforementioned problems, exemplary embodiments of the present invention provide a system and method for providing an advertisement rankings reflecting the quality of content and for providing user benefit enabled advertisements.

The above information disclosed in this Background section is only for enhancement of understanding of the background of the invention and therefore it may contain information that does not form any part of the prior art nor what the prior art may suggest to a person of ordinary skill in the art.

### SUMMARY

Exemplary embodiments of the present invention provide an advertisement providing system and method for controlling an advertisement rank based on a user benefit associated with an advertisement.

Exemplary embodiments of the present invention provide an advertisement providing system and method that may prevent the distortion of a quality index of an advertisement and reflect the quality of an advertisement on the quality index.

Exemplary embodiments of the present invention provide an advertisement providing system and method that may display an advertisement of higher quality in a higher rank based on the display rank determined by reflecting the quality of the advertisement on the quality index and reducing the factor of the user benefit.

Additional features of the invention will be set forth in the description which follows, and in part will be apparent from the description, or may be learned by practice of the invention.

An exemplary embodiment of the present invention discloses a system to control an advertisement rank, including a storage device; an advertisement identifying unit stored on the storage device and configured to identify advertisements, the identified advertisements corresponding to a keyword; an affiliate advertisement identifying unit configured to identify an affiliate advertisement among the identified advertisements, the affiliate advertisement being associated with a user benefit; and a rank index calculating unit comprising a processor configured to calculate a rank index of the affiliate advertisement based on a value of the user benefit.

An exemplary embodiment of the present invention discloses a method that uses a processor to control an advertisement rank, including determining multiple advertisements corresponding to a keyword; identifying an affiliate advertisement among the identified advertisements, the affiliate advertisement being associated with a user benefit; and calculating, by the processor, a rank index of the affiliate advertisement based on a value of the user benefit.

An exemplary embodiment of the present invention discloses a non-transitory computer-readable medium including a program for instructing a computer, when executed by a processor, to perform: determining multiple advertisements corresponding to a keyword; identifying an affiliate advertisement among the identified advertisements, the affiliate advertisement being associated with a user benefit; and calculating, by the processor, a rank index of the affiliate advertisement based on a value of the user benefit.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a diagram illustrating a network relationship among an advertiser, an advertising platform, a publisher, and a user in an advertisement system according to an exemplary embodiment of the present invention.

FIG. 2 is a diagram illustrating a network relationship among a member, an affiliate, and an advertisement providing system in an advertisement system according to an exemplary embodiment of the present invention.

FIG. 3 is a flowchart illustrating the accumulation and use of cash back rewards according to an exemplary embodiment of the present invention.

FIG. 4 is a diagram illustrating a website display displaying an advertisement of an advertiser according to an exemplary embodiment of the present invention.

FIG. 5 is a diagram illustrating a website display displaying an advertisement of an advertiser according to an exemplary embodiment of the present invention.

FIG. 6 is a diagram illustrating an order page of a website associated with an advertiser according to an exemplary embodiment of the present invention.

FIG. 7 is a diagram illustrating a method for calculating a rank index according to an exemplary embodiment of the present invention.

FIG. 8 is a block diagram illustrating a system to control an advertisement rank based on a user benefit according to an exemplary embodiment of the present invention.

FIG. 9 is a flowchart illustrating a method for controlling an advertisement rank based on a user benefit according to an exemplary embodiment of the present invention.

### DETAILED DESCRIPTION OF THE ILLUSTRATED EMBODIMENTS

Exemplary embodiments will be described more fully hereinafter with reference to the accompanying drawings, in which exemplary embodiments of the invention are shown. This invention may, however, be embodied in many different forms and should not be construed as limited to the exemplary embodiments set forth herein. Rather, these embodiments are provided so that this disclosure is thorough, and will fully convey the scope of the invention to those skilled in the art. Throughout the drawings and the detailed description, unless otherwise described, the same drawing reference numerals are understood to refer to the same elements, features, and structures. The relative size and depiction of these elements may be exaggerated for clarity, illustration, and convenience

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, units, modules, integers, steps, operations, elements, components, etc., but do not preclude the presence or addition of one or more other features, regions, units, modules, integers, steps, operations, elements, components, etc., and/or groups thereof.

It will be understood that for the purposes of this disclosure, “at least one of” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, YZ, X). Further, “at least two of X, Y, and Z” will be construed to mean any combination of two or more items X, Y, and Z (e.g. XYZ, XZ, YZ, XY). It will be understood that when an element is referred to as being “connected to” another element, it can be directly connected to the other element, or intervening elements may be present. In contrast, when an element is referred to as being “directly connected to” another element, there are no intervening elements present.

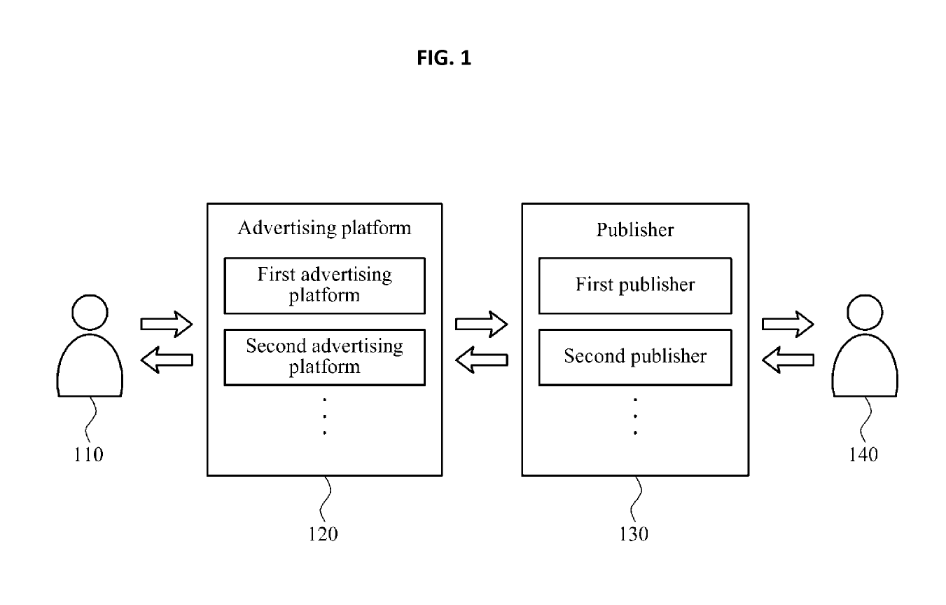

FIG. 1 is a diagram illustrating a network relationship among an advertiser, an advertising platform, a publisher, and a user in an advertisement system according to an exemplary embodiment of the present invention. As shown in FIG. 1, an advertiser 110, an advertising platform 120, a publisher 130, and a user 140 may be connected via a network. The advertiser 110 and the user 140 may be terminals of the advertiser 110 and the user 140, such as, for example, personal computers (PCs), smart phones, tablet computer, and the like. Arrows shown in FIG. 1 indicate transmissions of data between a terminal of the advertiser 110, the advertising platform 120, the publisher 130, and a terminal of the user 140 via a wired/wireless network.

The advertising platform 120 may be a system that executes operations of advertisement bidding of the advertiser 110, matching advertisements and keywords, arranging advertisements or advertisers, providing advertisements to the publisher 130, charging advertising fees, and the like. Since the general technical features of the advertising platform 120 can be understood by referring to a conventional search and/or banner advertising platform provided via an Internet, a detailed description is omitted herein for conciseness and ease of explanation.

The term “publisher” as stated herein may be used interchangeably with a “website” or may include the “website”. Further, the usage of the term “website” in the following description is not intended to limit the scope of the invention. The present invention may also be implemented in an environment other than where an application display is executed in a mobile terminal or a website is accessed by a general PC. Further, the term “website” may correspond to a publishing site or individual publishers included in the publisher 130, for example, a first publisher, a second publisher, and the like. Further, the “website” may include all types of websites that can display and provide advertisements to users via a wired/wireless network, and may include one webpage constituting a website.

The term “displaying” of an advertisement may include providing a promotional content of a corresponding advertiser, such as, for example, text, images, sounds, videos, or hyperlinks, to a website (publisher) visitor, for example, the user 140, via the corresponding website. Further, “selecting” of the displayed advertisement may mean that the user (website visitor) responds to the displayed promotional content of the advertiser, such as text or images, for example, by clicking using a mouse, to bring about an event intended to be achieved through the advertiser delivering the promotional content. Here, the event intended by the advertiser may include, for example, an event in which a webpage associated with the advertiser is displayed to the user who selected the advertisement, or an event that a user joins a membership through the webpage displayed by selecting the advertisement.

An occurrence of an event induced by the advertiser may be referred to as “conversion”. For example, if an event intended by the advertiser is “selection” of the displayed advertisement, for example, by clicking, “conversion” may correspond to a click from the user. If an event intended by the advertiser is a transaction of a product through the displayed advertisement, “conversion” may correspond to a sale of a product intended to be sold through the displayed advertisement. If an event intended by the advertiser is a membership registration on the website accessed by the user through the displayed advertisement, “conversion” may correspond to a registration for the membership.

The publisher 130 may provide a website of the publisher 130 to the user 140 and may provide a webpage constituting the website to the user 140 through the website or provide a search result for a keyword inputted through the website to the user 140 using the keyword. The publisher 130 may receive an advertisement to be displayed or provided via the webpage from the advertising platform 120 and may provide the advertisement to the user 140. For example, the publisher 130 may transmit a keyword inputted by the user 140 to the advertising platform 120, and may receive an advertisement for the keyword from the advertising platform 120 and then provide the advertisement as a search result to the user 140. Further, the publisher 130 may determine an advertisement to be provided as a search result using a keyword inputted by the user 140 and may request information about the determined advertisement from the advertising platform 120. The publisher 130 may add information about the advertisement received from the advertising platform 120 to the search result and may provide the information to the user 140 along with the search result.

The publisher 130 may provide a channel (e.g., a display) through which the user 140 is provided with an advertisement, and in a general online environment, may provide the advertisement through a website. A plurality of individual advertising platforms included in the advertising platform 120, e.g., a first advertising platform, a second advertising platform, and the like, may display an advertisement through at least one of a plurality of the individual publishers included in the publisher 130, e.g., a first publisher, a second publisher, and the like. Further, each of a plurality of individual publishers included in the publisher 130 may provide at least one of the various services that can be provided via a wired/wireless network, such as, for example, a unified search, a keyword search, a blog service, and the like, to the user 140 through at least one website, as well as displaying the advertisement.

The advertisement providing system may be one of the systems operating in the individual advertising platforms or a system included in one of the systems operating in the individual advertising platforms. In this case, the advertisement providing system may receive information relating to the user from at least one of the systems associated with the individual publishers, and then use the received information.

The advertisement providing system may be one of the systems associated with the individual publishers or a system included in one of the systems associated with the individual publishers. In this case, the advertisement providing system may receive information relating to the advertiser from at least one of the systems operating in the individual advertising platforms, and then use the received information.

The advertisement providing system may receive an input of related information from the advertiser or the user, or may receive related information through at least one of a corresponding advertising platform and a corresponding publisher. Hereinafter, in the description of the advertisement providing system and method that follows, a network relationship with the advertising platform or publisher may be omitted for conciseness and convenience of description.

The term “cash back rewards” as used herein may be indicated in terms of a unit of money used in the real world, or may be indicated in terms of points or mileages of electronic cash corresponding to the unit of money used in the real world. The electronic cash may be related to money used in the real world by a ratio, for example, 1:1, 1:10, and the like. The ratio may be changed. The “cash back rewards” is used as an example of a user benefit offered to a user when the user 140 selects a displayed search result or achieve a condition set by the advertiser. However, the user benefit is not limited as such. For example, the user benefit may be provided in the form of a discount coupon, and the like.

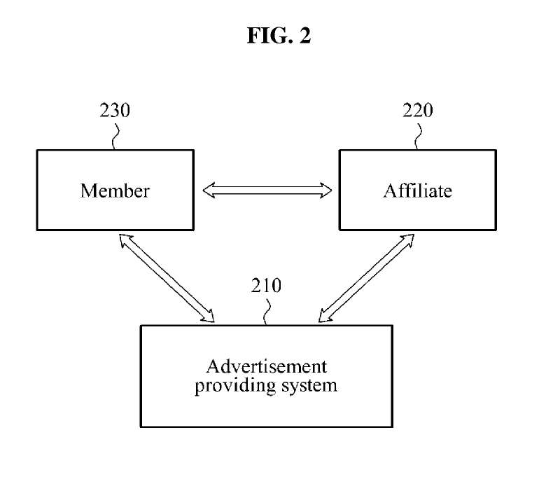

FIG. 2 is a diagram illustrating a network relationship among a member, an affiliate, and an advertisement providing system in an advertisement system according to an exemplary embodiment of the present invention. As shown in FIG. 2, an advertisement providing system 210, an affiliate 220, and a member 230 are connected via a network. The affiliate 220 may be, e.g., the advertiser 110 of FIG. 1, an advertiser who agrees to or indicates an intention to display information relating to a determined user benefit, such as, for example, a cash back rate of cash back rewards, along with an advertisement, or may be a website of the advertiser. The member 230 may be a user who accesses a publisher and is provided with an advertisement displayed through the publisher.

Hereinafter, an example of cash back rewards offered as a predetermined user benefit will be described briefly. For example, cash back rewards may include at least one of the three types of cash back rewards as follows:

1. Basic cash back reward: if the member 230 visits the affiliate 220 and purchases a product or service, may receive a reward according to a determined proportion of the price of the product or service.

2. First additional cash back reward: if the member 230 visits the affiliate 220 through an access channel set by the advertisement providing system 210 or an operator of the advertisement providing system 210 and purchases a product or service, may receive a reward according to a determined proportion of the price of the product or service.

3. Second additional cash back reward: if the member 230 visits the affiliate 220 and purchases a product or service by a payment method in accordance with the terms of affiliation set by the advertisement providing system 210 or an operator of the advertisement providing system 210, such as, for example, a service for integrated payment or credit card payment, may receive a reward according to a determined proportion of the price of the product or service.

The access channel may include a channel used when the member 230 accesses the affiliate 220 through a certain website, and a channel used when the member 230 accesses the affiliate 220 through a website and then accesses the affiliate 220 through an advertisement displayed by a certain advertising method of the corresponding website, depending on the settings of the advertisement providing system 210. For example, the advertising method may include (1) search advertising, a method of providing information related to an advertisement of an advertiser who bought a keyword included in a search word in response to an input of the search query, and (2) shopping advertising, a method of providing information related to a product corresponding to a search query and information relating to a website of an advertiser who sells the product in response to an input of the search query. Also, the access channel may include a channel used when the member 230 accesses the affiliate 220 by inputting a uniform resource locator (URL).

The service for integrated payment is a payment processing service that enables the member 230 to pay for a product or service purchased at the affiliate 220 using identification (ID) and password registered when the member 230 signs up for a website (individual publisher) associated with the advertisement providing system 210 in partnership with the affiliate 220 for the service for integrated payment. Since the service for integrated payment method is well known in the art, a detailed description will be omitted herein.

Cash back rewards to be offered to the member 230 after paying for a product or service may be determined using at least one of the three types of cash back rates. In other words, the advertisement providing system 210 may determine cash back rewards of the member 230 to be offered to the member 230 after paying for a product or service using at least one of the three types of cash back rates below and then offer the determined cash back rewards to the member 230. Here, the cash back rate may be a ratio of the cash back rewards to the price of the product or service.

1. Basic cash back rate: if the member 230 visits the affiliate 220 and purchases a product or service, a ratio of basic cash back reward to be offered to the member 230 to the price of the product or service.

2. First additional cash back rate: if the member 230 visits the affiliate 220 through an access channel set by the advertisement providing system 210 or an operator of the advertisement providing system 210 and purchases a product or service, a ratio of first additional cash back reward to be offered to the member 230 to the price of the product or service.

3. Second additional cash back rate: if the member 230 visits the affiliate 220 and purchases a product or service by a payment method in accordance with the terms or conditions of affiliation set by the advertisement providing system 210 or an operator of the advertisement providing system 210, such as, for example, a service for integrated payment or credit card payment, a ratio of second additional cash back reward to be offered to the member 230 to the price of the product or service.

For example, the basic cash back rate may be set by the affiliate 220 in a minimum/maximum cash back rate range set by the advertisement providing system 210 or an operator of the advertisement providing system 210. The first additional cash back rate may be set by a corresponding individual publisher, the advertisement providing system 210, an operator of the advertisement providing system 210, or the affiliate 220, in consideration of maximum cash back in the advertising revenue and marketing effects. The second additional cash back rate may be set by an agreement between a corresponding individual publisher and the affiliate 220.

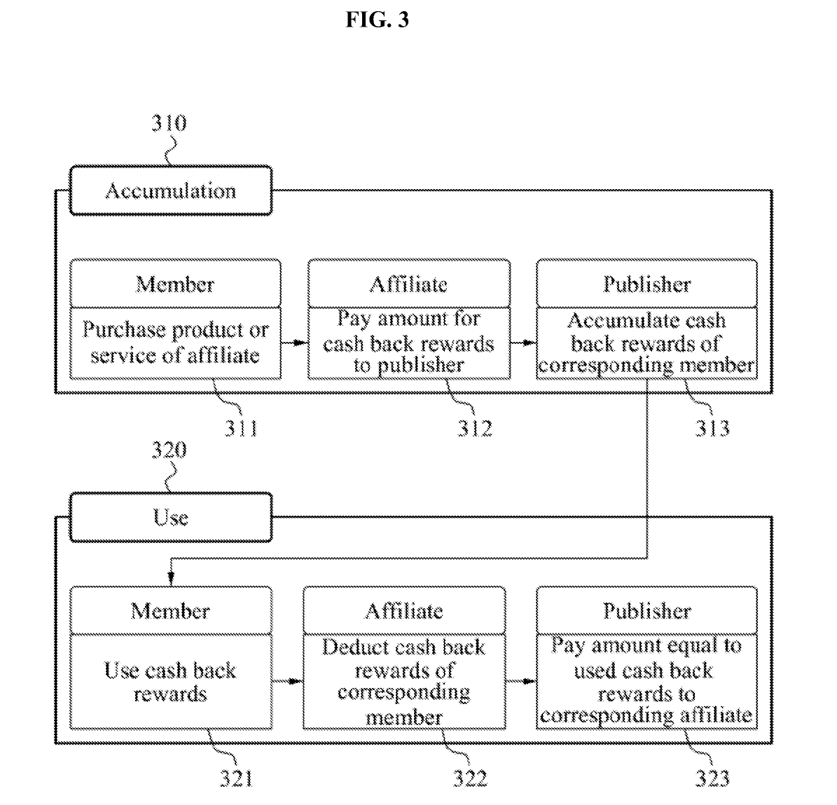

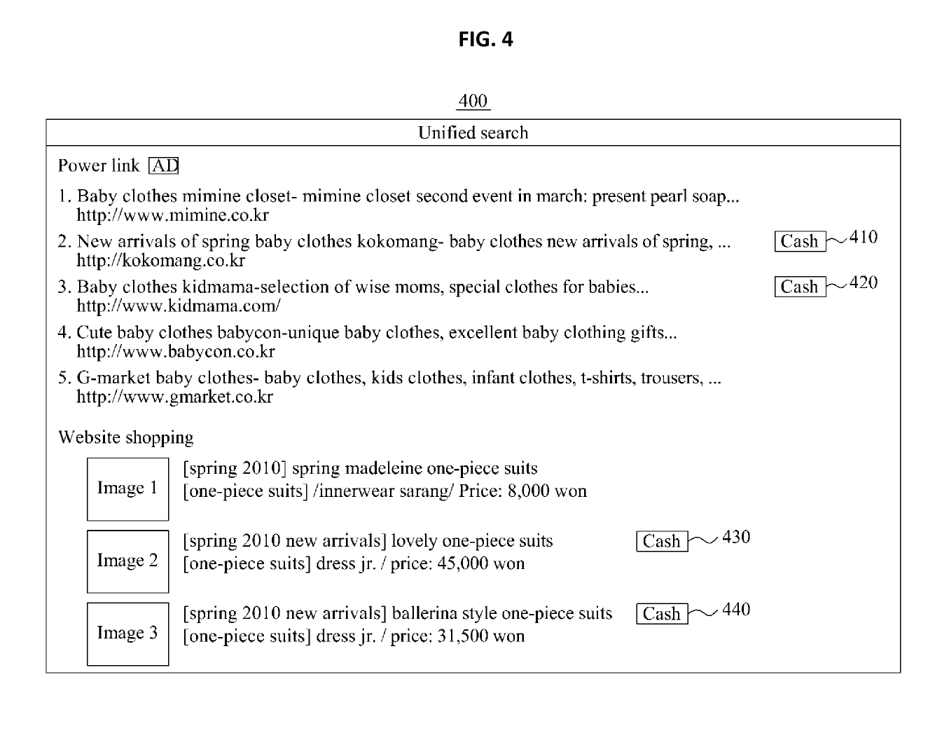

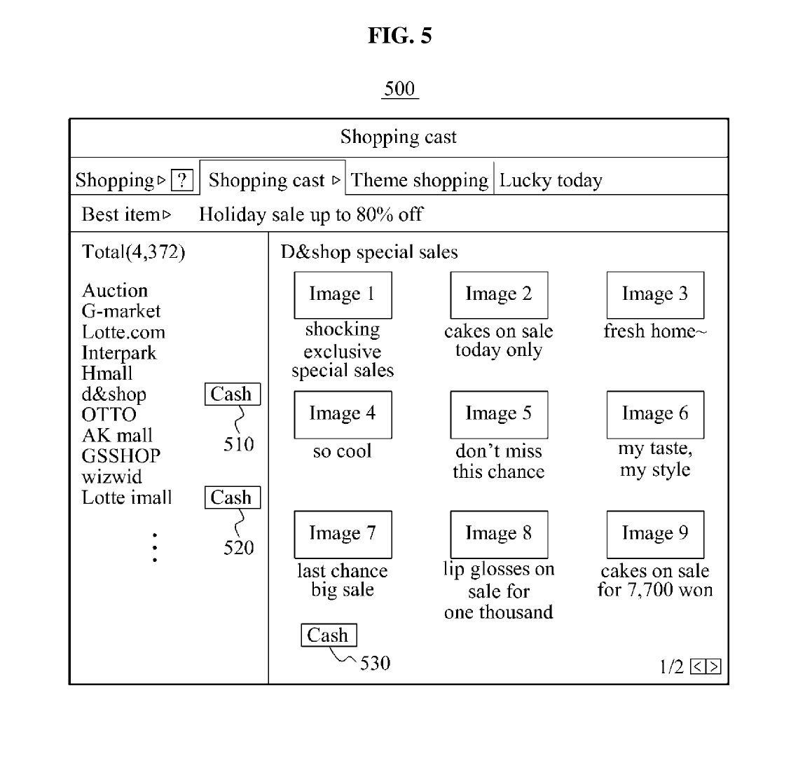

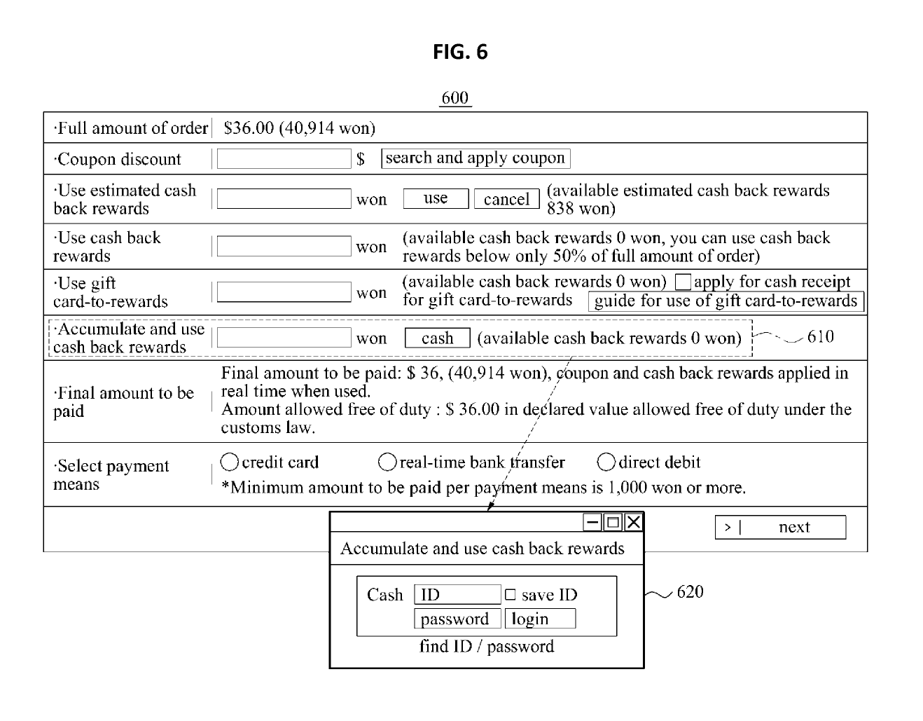

Hereinafter, an operation of accumulating and using cash back rewards, an operation of indicating an affiliate, and a method for providing information relating to a cash back rate will be described with reference to FIG. 3, FIG. 4, FIG. 5, and FIG. 6.

FIG. 3 is a flowchart illustrating the accumulation and use of cash back rewards according to an exemplary embodiment of the present invention. In FIG. 3, an accumulation operation 310 and a use operation 320 are shown.

The accumulation operation 310 includes an operation 311 in which the member 230 purchases a product or service of the affiliate 220, an operation 312 in which the affiliate 220 pays the amount for cash back rewards to the publisher, and an operation 313 in which the publisher accumulates the cash back rewards of the corresponding member 230. For example, if the member 230 accesses the affiliate 220 and purchases a product or service, the affiliate 220 pays the amount for cash back rewards to the publisher, and the publisher accumulates the cash back rewards of the corresponding member 230.

The use operation 320 includes an operation 321 in which the member 230 uses the cash back rewards, an operation 322 in which the publisher deducts the cash back rewards of the corresponding member 230, and an operation 323 in which the publisher pays the amount equal to the used cash back rewards to the corresponding affiliate 220. For example, if the member 230 uses a portion or all of the accumulated cash back rewards for the purchase of a product or service of the affiliate 220, the publisher deducts the redeemed cash back rewards of the member 230 and pays the amount equal to the redeemed cash back rewards to the corresponding affiliate 220.

FIG. 4 is a diagram illustrating a website display displaying an advertisement of an advertiser according to an exemplary embodiment of the present invention. A display 400 of FIG. 4 is an example of a part of a website (publisher) display on which advertisements of the advertiser 110 of FIG. 1 are displayed. Advertisements including “cash” icons 410, 420, 430, and 440 may be an advertisement for which user benefits, e.g., cash back rewards, are offered. For example, the “cash” icons 410, 420, 430, and 440 may be displayed for an advertisement of an advertiser that is accepted as an affiliate allowing cash back rewards.

If the member 230 accesses a corresponding website via a hyperlink of an advertisement including one of the “cash” icons 410, 420, 430, and 440 and purchases a corresponding product or service, the member 230 may receive a benefit or a cash back reward that may be a proportion of the price of the product or service.

FIG. 5 is a diagram illustrating a website display displaying an advertisement of an advertiser according to an exemplary embodiment of the present invention. A display 500 of FIG. 5 is an example of a part of a website (publisher) display on which advertisements of the advertiser 110 are displayed. In the display 500, “cash” icons 510 and 520 may indicate that cash back rewards are set for the entire items of a shopping mall of a specific advertiser rather than for an individual product or service. The “cash” icons 510 and 520 may indicate that cash back rewards are set for all products or services available for purchase via the shopping mall of the specific advertiser. Further, a “cash” icon 530 may indicate that cash back rewards are set for an individual product or service corresponding to a product of the image 7.

As shown in FIG. 4 and FIG. 5, when a specific advertisement is displayed, reward information whether cash back rewards will be offered may be displayed together. Further, information relating to a cash back rate of the cash back rewards may be displayed together. For example, if it is determined to offer “3%” cash back rewards to a user who purchases a product via an advertisement corresponding to the “cash” icon 410, information of “3%” cash back rewards may be displayed along with the “cash” icon 410.

FIG. 6 is a diagram illustrating an order page of a website associated with an advertiser according to an exemplary embodiment of the present invention. A display 600 is an example of a part of an order page for purchasing a product of a specific affiliate. A dotted box 610 shows an icon indicating that cash back rewards will be accumulated and a user interface to enable a user to use the existing cash back rewards. For accumulation and use of cash back rewards, a login to a website associated with a publisher may be requested. A log-in box 620 indicates a user interface for login to a website associated with a publisher. A user may be identified as a member by logging into a website associated with a publisher using the log-in box 620.

An affiliate may determine whether to display a “cash” icon and set a value of a basic cash back rate or whether to set an additional cash back rate through authentication when joining as an affiliate. For example, affiliates may determine a basic cash back rate when joining as an affiliate. If an affiliate has established a partnership for the service for integrated payment, the affiliate may determine whether to set a second additional cash back rate when joining as an affiliate. Further, an affiliate may change reward information or reward conditions even after joining as an affiliate.

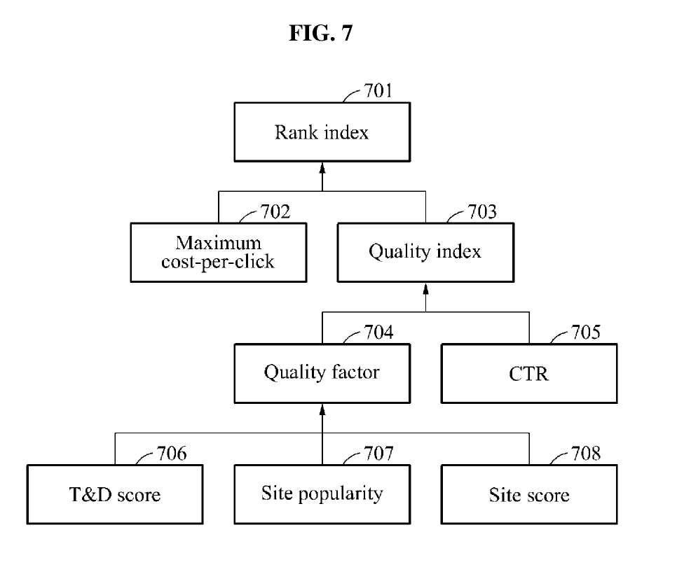

FIG. 7 is a diagram illustrating a method for calculating a rank index according to an exemplary embodiment of the present invention. According to a rank index, a displaying order of an advertisement may be determined. The method for calculating a rank index will be illustrated as an exemplary embodiment to help the understanding of a method for controlling an advertisement rank based on a user benefit, but is not limited as such.

As shown in FIG. 7, a rank index 701 may be calculated using a maximum cost-per-click (CPC) 702 and a quality index 703, and the quality index 703 may be calculated using a quality factor 704 and a click-through rate (CTR) 705. The quality factor 704 may be obtained using a title and description (T&D) score 706, a site popularity 707, and a site score 708.

To calculate the rank index 701, the advertisement providing system may assign a first weight value to the maximum CPC 702 and a second weight value to the quality index 703, and may multiply the weighted maximum CPC and the weighted quality index. Accordingly, the rank index 701 may be represented by mathematical formula 1:

Rank Index=(First Weight Value*Max CPC)*(Second Weight Value*Quality Index) [Mathematical Formula 1]

The maximum cost-per-click (CPC) 702 is a maximum cost to be paid by an advertiser of an advertisement registered for a keyword when the advertisement is clicked. For example, the maximum CPC may be the maximum value of advertiser's willingness to pay per click. A minimum value of the maximum CPC 702 may be limited by determining a minimum bid amount allowable to the advertiser for the keyword.

The quality index 703 may be calculated by a combination of the quality factor 704 as a pre-evaluation factor of an advertisement listing and the CTR 705 as a post-evaluation factor, and may be used to evaluate the quality of the advertisement listing.

In particular, the quality index 703 may be calculated by assigning a third weight value to the quality factor 704 and a fourth weight value to the CTR 705 and adding the weighted quality factor to the weighted CTR, and may be represented by mathematical formula 2:

Quality Index=(Third Weight Value*Quality Factor)+(Forth Weight Value*CTR) [Mathematical Formula 2]

The sum of the third weight value and the fourth weight value may be set to have a constant value (e.g., “W3+W4=C”). For example, the sum may be ‘1’. The advertisement providing system may apply a weight value to the pre-evaluation factor or post-evaluation factor by adjusting a ratio between the third weight value and the fourth weight value. The advertisement providing system may provide an advertisement using an initial third weight value and an initial fourth weight value, and may adjust a ratio between the third weight value and the fourth weight value through analysis of a correlation between the quality index 703, the CTR 705, and the sale of the advertisement.

The CTR 705 may reflect a click factor (CF) indicating a post response of a user. The CF may be calculated based on the number of responses to an advertisement, for example, the number of clicks, after the advertisement is displayed. For example, the CF may have a value between 0.5 and 2 by applying an s-curve transformation to a ratio of the number of clicks to the estimated number of clicks for each location where an advertisement is displayed.

The quality index 703 may have a more objective value by correcting a difference in a maximum limit and a minimum limit of advertisement listings displayed for a keyword such that the difference is within a predetermined value.

The quality factor 704 may be determined based on at least one of the T&D score 706, the site popularity 707, and the site score 708 associated with an advertisement. The advertisement providing system may determine the quality factor 704 using one or more factors including the T&D score 706, the site popularity 707, and the site score 708. If the T&D score 706, the site popularity 707, and the site score 708 are used, mathematical formula 2 may be expressed by mathematical formula 3:

Quality Index=(Third Weight Value*((Fifth Weight Value*T&D Score)+(Sixth Weight Value*Site Popularity)+(Seventh Weight Value*Site Score)))+(Fourth Weight Value*CTR) [Mathematical Formula 3]

The T&D score 706 is a measure of the relevance of title and description set by an advertiser of an advertisement. The T&D score 706 may be determined based on a first relevance indicating the relevance between a keyword and T&D and a second relevance indicating the relevance between words in T&D. For example, the T&D score 706 may be determined by the sum of the first relevance and the second relevance.

The site popularity 707 is a hierarchy system established using the number of times a user visits a website (“web visiting count”), the user satisfaction, and the relevance. Since the distribution of advertising websites may be skewed, the site popularity 707 may be used to correct the quality index 703, in particular, the quality factor 704 as a pre-evaluation factor.

The site score 708 is a measure of the relevance between a website and a keyword determined by crawling on the website. The seventh weight value may be adjusted depending on a crawling depth and technique. For example, the relevance or content match (CM) of a website of an advertiser or a score for determining the web search ranking on a search algorithm may be used. If the score for determining the web search ranking on a search algorithm is used, the score may be used to determine the site score 708 or the seventh weight.

As described above, when calculating a display rank of an advertisement, a post-evaluation factor such as a CF, for example, a CTR may be reflected. However, a user benefit may generate noise, such as noise clicks induced by the user benefit, in the CF. Accordingly, by controlling an advertisement ranking based on a user benefit, the advertisement providing system may guarantee the advertising effects based on the display rank.

The advertisement providing system may reflect a user benefit on a CF as a post-evaluation factor, as represented by mathematical formula 4:

CF=f(CTR,Cash Back Rate) [Mathematical Formula 4]

where a CF is defined as a function f( ) of a ‘CTR’ and a ‘cash back rate’. The advertisement providing system may reduce the CF or the CTR based on the cash back rate. For example, the advertisement providing system may reduce the CTR at a greater rate with a higher cash back rate. As the CTR reduces, the quality index and the rank index may be reduced. In mathematical formula 4, the cash back rate is used as an example of a user benefit.

Further, the advertisement providing system may reflect a user benefit on a CF as a post-evaluation factor, as represented by mathematical formulae 5 and 6:

Controlled CTR=CTR−Normalized Cash Back Rate [Mathematical Formula 5]

Controlled CTR=CTR*(1−Normalized Cash Back Rate) [Mathematical Formula 6]

The advertisement providing system may eliminate the induced clicks induced from a user benefit by calculating a rank index using the controlled CTR. The ‘normalized cash back rate’ may be a cash back rate adjusted to be consistent with a CTR. For example, if the CTR has a value in a range of 0 to 1, the normalized cash back rate may be adjusted to have a value in a range of 0 to 1.

The controlled CTR calculated in mathematical formula 5 or 6 may be used as a CF.

According to another exemplary embodiment, the advertisement providing system may control the advertisement ranking based on a user benefit in aspect of a conversion rate. The conversion rate may be a ratio of the number of product purchases to the number of advertisement displays to a user or a ratio of the number of product purchases to the number of advertisement selections by a user.

The advertisement providing system may control the conversion rate based on a user benefit. A functional relation between a conversion rate and a cash back rate may be applied. The functional relation may correspond to the functional relation between the CTR and the cash back rate described in mathematical formula 4. For example, if the cash back rate increases, the conversion rate may be reduced. The mathematical formula 5 and 6 may be used by replacing the CTR with the conversion rate.

Here, conversion is not limited to the purchase of a product or service and may be extended to an “action” determined by an advertiser as described in the above.

Further, the advertisement providing system may reflect a conversion rate on a quality index. If conversion such as the purchase of a product or service is performed in a website or a server of an advertiser, the advertisement providing system may not recognize the occurrence of conversion without feedback of the advertiser. However, if cash back rewards are offered, the advertisement providing system may recognize the purchase of a product or service through the cash back rewards.

The advertisement providing system may reflect a conversion rate on a quality index. For example, the quality index reflecting the conversion rate may be calculated by mathematical formula 7:

Quality Index=α(Click Factor)+β(Quality Factor)+γ(Conversion Factor) [Mathematical Formula 7]

where each of ‘α’, ‘β’, and ‘γ’ may be weight values, the ‘click factor’ may be a post-evaluation factor, the ‘quality factor’ may be a pre-evaluation factor, and the ‘conversion factor’ may be the conversion rate.

The advertisement providing system may reflect the quality of an advertisement on the display rank by controlling the factor caused by a user benefit.

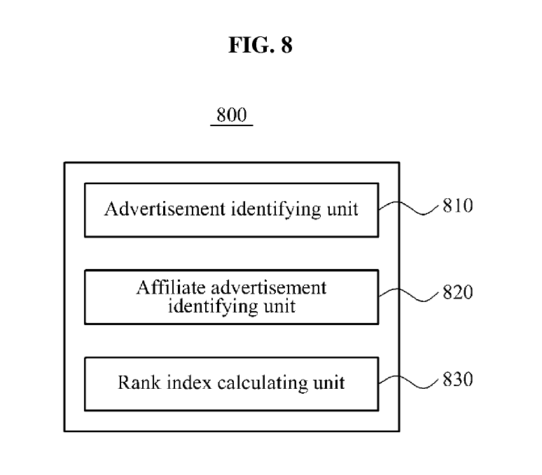

FIG. 8 is a block diagram illustrating a system to control an advertisement rank based on a user benefit according to an exemplary embodiment of the present invention. As shown in FIG. 8, the advertisement providing system 800 includes an advertisement identifying unit 810, an affiliate advertisement identifying unit 820, and a rank index calculating unit 830.

The advertisement identifying unit 810 may identify advertisements to be displayed for a determined keyword. The determined keyword may be included in a search query inputted by a user. If a search query is inputted by a user via an input interface of a search website, the publisher may receive information relating to advertisements from the advertising platform and may display the advertisements received as a search result on the website. For example, the advertisement identifying unit 810 may identify advertisements to be displayed as a search result in advance.

The affiliate advertisement identifying unit 820 may identify an advertisement of an affiliate agreeing to provide a user benefit to a user who purchases a product or service of the affiliate, among the identified advertisements. As described in the above, the affiliate may offer a user benefit, such as, for example, cash back rewards to a user who purchases a product or service of the affiliate. The affiliate advertisement identifying unit 820 may identify an affiliate's advertisement among advertisements to be displayed. For example, the affiliate advertisement identifying unit 820 may receive affiliate identification information, or information of benefits provided by at least one of the affiliate and the advertisement providing system 800. Further, the affiliate advertisement identifying unit 820 may determine whether benefit information (e.g., cash icons 410, 420, 430, and 440) is provided along with an advertisement to distinguish the affiliates' advertisements.

The rank index calculating unit 830 may calculate a rank index of the identified advertisements. The rank index calculating unit 830 may calculate a rank index of the affiliate advertisement by lowering the rank index based on the user benefit. Based on the calculated rank index, the rank index calculating unit 830 may determine a display rank of each of the identified advertisements. If the affiliate advertisement is displayed, information relating to the user benefit, such as, for example, a cash back rate of the cash back rewards may be displayed together. Since the privilege or customer inducement occurs from the user benefit, the advertising effects based on the display rank may not be guaranteed. The user benefits may inflate the display rank by inducing more clicks. Thus, by reflecting the user benefit on the rank index or the display rank, the advertising effects based on the display rank may be guaranteed.

For example, the user benefit may include cash back rewards offered to a user. In this case, the rank index calculating unit 830 may calculate the rank index of the affiliate advertisement by lowering the rank index based on a cash back rate of the cash back rewards.

The rank index may be calculated based on a quality index of the advertisement and a maximum CPC inputted by the advertiser of the advertisement. The quality index may be calculated using at least one of a quality factor (QF) as a pre-evaluation factor of the advertisement, a click factor (CF) indicating the post response of the user, and a conversion rate representing a ratio of the number of conversions to the number of advertisement displays to the user or the number of advertisement selections by the user. An example of a method for calculating the quality index using the quality factor and the click factor is described with reference to mathematical formula 2, and an example of a method for calculating the quality index using the quality factor, the click factor, and the conversion rate is described with reference to mathematical formula 7. In addition to the calculation methods described with reference to mathematical formulae 2 and 7, the quality index may be calculated using the quality factor and the conversion rate.

Further, the rank index calculating unit 830 may calculate the rank index by lowering the click factor or the conversion rate based on the user benefit. The greater the user benefit, the greater the reduction of the click factor or the conversion rate, for example.

The user benefit may include, for example, a cash back rate of cash back rewards offered to the user, and the click factor may include, for example, a CTR of the advertisement.

For example, a method for adjusting the click factor is described with reference to mathematical formula 4. As the click factor is adjusted, the rank index calculated using the click factor may be also adjusted.

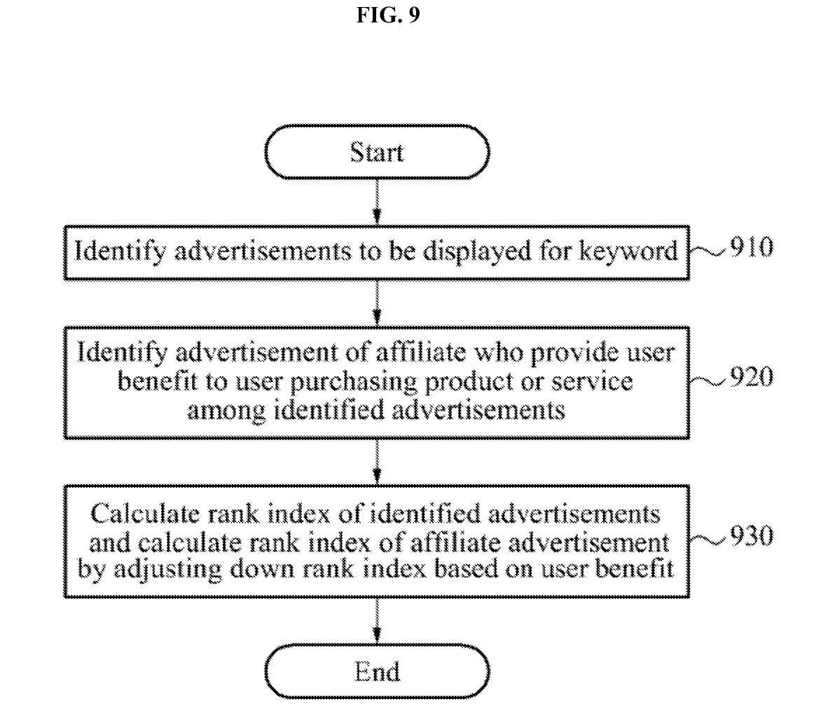

FIG. 9 is a flowchart illustrating a method for controlling an advertisement rank based on a user benefit according to an exemplary embodiment of the present invention. The advertisement providing method may be performed by the advertisement providing system 800, but is not limited as such.

In operation 910, the advertisement providing system 800 may identify advertisements to be displayed for a keyword. The keyword may be included in a search query inputted by a user. If a search query is inputted by a user via an input interface of a website, the publisher may receive information relating to advertisements from the advertising platform and may display the advertisements received as a search result via the website. For example, the advertisement providing system 800 may identify advertisements to be displayed as a search result in advance.

In operation 920, the advertisement providing system 800 may identify an advertisement of an affiliate agreeing to provide a user benefit to a user among the identified advertisements. The affiliate may offer a user benefit, such as, for example, cash back rewards to a user who purchases a product or service provided by the affiliate. For example, the affiliate advertisement identifying unit 820 may identify an affiliate advertisement among advertisements to be displayed based on user benefit information associated with an advertisement.

In operation 930, the advertisement providing system 800 may calculate a rank index of the identified advertisements. The advertisement providing system 800 may calculate a rank index of the affiliate advertisement by lowering the rank index based on the user benefit.

Based on the calculated rank index, the advertisement providing system 800 may determine a display rank of each of the identified advertisements. If the affiliate advertisement is displayed, information relating to the user benefit, such as, for example, a cash back rate of the cash back rewards may be displayed together.

For example, the user benefit may include cash back rewards offered to a user. The advertisement providing system 800 may calculate the rank index of the affiliate advertisement by lowering the rank index based on a cash back rate of the cash back rewards.

The rank index may be calculated based on a quality index of the advertisement and a maximum CPC inputted by the advertiser of the advertisement. The quality index may be calculated using at least one of a quality factor (QF) as a pre-evaluation factor of the advertisement, a click factor (CF) indicating feedback information from users, and a conversion rate representing a ratio of the number of conversions to the number of advertisement displays to the user or the number of advertisement selections by the user. An example of a method for calculating the quality index using the quality factor and the click factor is described with reference to mathematical formula 2, and an example of a method for calculating the quality index using the quality factor, the click factor, and the conversion rate is described with reference to mathematical formula 7. Further, the quality index may be calculated using the quality factor and the conversion rate.

Further, the advertisement providing system 800 may calculate the rank index by lowering the click factor or the conversion rate based on the user benefit. The lowering degree may be increased if the user benefit increases.

The user benefit may include, for example, a cash back rate of cash back rewards offered to the user and the click factor may include, for example, a CTR of the advertisement. As an example, a method for adjusting the click factor is described with reference to mathematical formula 4. As the click factor is adjusted, the rank index calculated using the click factor may be also adjusted.

By controlling parameters based on a user benefit, the advertising effects based on the display rank may be controlled. Further, the distortion of a quality index may be prevented and the quality of advertisements may be reflected on the quality index.

The exemplary embodiments according to the present invention may be recorded in non-transitory computer-readable media including program instructions to implement various operations embodied by a computer including one or more processors. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM discs and DVD; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A system to control an advertisement rank, comprising:
a storage device;
an advertisement identifying unit stored on the storage device and configured to identify advertisements, the identified advertisements corresponding to a keyword;
an affiliate advertisement identifying unit configured to identify an affiliate advertisement among the identified advertisements, the affiliate advertisement being associated with a user benefit; and
a rank index calculating unit comprising a processor configured to calculate a rank index of the affiliate advertisement based on a value of the user benefit.

2. The system of claim 1, wherein the rank index calculating unit is configured to determine a display rank of the affiliate advertisement based on the calculated rank index and rank indexes of the identified advertisements.

3. The system of claim 1, wherein the user benefit comprises cash back rewards or a discount coupon, and
the rank index calculating unit is configured to calculate the rank index of the affiliate advertisement by lowering the rank index based on a cash back rate of the cash back rewards or a discount rate of the discount coupon.

4. The system of claim 1, wherein the rank index is calculated based on a quality index of the affiliate advertisement and a maximum cost-per-click (CPC), and
the quality index is calculated using at least two of a quality factor, a click factor, and a conversion rate.

5. The system of claim 4, wherein the rank index calculating unit is configured to calculate the rank index by lowering the click factor or the conversion rate based on the user benefit.

6. The system of claim 5, wherein the rank index calculating unit is configured to calculate a decrease in the click factor or the conversion rate according to an increase in the value of the user benefit.

7. The system of claim 1, wherein the rank index calculating unit is configured to calculate a decrease in the rank index according to an increase in the value of the user benefit.

8. The system of claim 4, wherein the user benefit comprises a cash back rate of cash back rewards or a discount rate of a discount coupon, and
the click factor is determined based on a click through rate of the affiliate advertisement.

9. A method that uses a processor to control an advertisement rank, comprising:
determining multiple advertisements corresponding to a keyword;
identifying an affiliate advertisement among the identified advertisements, the affiliate advertisement being associated with a user benefit; and
calculating, by the processor, a rank index of the affiliate advertisement based on a value of the user benefit.

10. The method of claim 9, further comprising:
determining a display rank of the affiliate advertisement based on the calculated rank index and rank indexes of the identified advertisements.

11. The method of claim 9, wherein the user benefit comprises cash back rewards or a discount coupon, and
calculating of the rank index comprises lowering the rank index based on a cash back rate of the cash back rewards or a discount rate of the discount coupon.

12. The method of claim 9, wherein the rank index is calculated based on a quality index of the affiliate advertisement and a maximum cost-per-click, and
the quality index is calculated using at least two of a quality factor, a click factor, and a conversion rate representing a ratio of a number of conversions to a number of advertisement displays or a ratio of a number of conversions to a number of advertisement selections.

13. The method of claim 12, wherein calculating of the rank index comprises calculating the rank index by lowering the click factor or the conversion rate based on the value of the user benefit.

14. The method of claim 12, further comprising:
calculating a decrease in the click factor or the conversion rate according to an increase in the value of the user benefit.

15. The method of claim 9, further comprising:
calculating a decrease in the rank index according to an increase in the value of the user benefit.

16. The method of claim 12, wherein the user benefit comprises a cash back rate of cash back rewards or a discount rate of a discount coupon, and the click factor is determined based on a click through rate of the affiliate advertisement.

17. The method of claim 9, further comprising:
calculating the rank index based on a quality index of the affiliate advertisement and a maximum cost-per-click value determined for the affiliate advertisement, and
controlling the quality index based on the value of the user benefit.

18. A non-transitory computer-readable medium comprising a program for instructing a computer, when executed by a processor, to perform the method of claim 9.

19. The non-transitory computer-readable medium of claim 18, wherein the user benefit comprises cash back rewards or a discount coupon, and
calculating of the rank index comprises calculating the rank index of the affiliate advertisement by lowering the rank index based on a cash back rate of the cash back rewards or a discount rate of the discount coupon.
